(19) United States
(12) Patent Application Publication
(10) Pub. No.: US 2023/0290993 A1
(43) Pub. Date: Sep. 14, 2023

(54) METHOD FOR PRODUCING BATTERY

(71) Applicant: Prime Planet Energy & Solutions, Inc., Tokyo (JP)

(72) Inventors: Kazutaka MITA, Kobe-shi (JP); Kunihiko HAYASHI, Miki-shi (JP)

(21) Appl. No.: 18/181,568

(22) Filed: Mar. 10, 2023

(30) Foreign Application Priority Data
Mar. 14, 2022 (JP) 2022-039649

(51) Int. Cl. H01M 10/04; H01M 10/0587

(52) U.S. Cl. CPC H01M 10/0431; H01M 10/0587

(57) ABSTRACT

A method for producing a battery disclosed herein has an electrode body production step of producing an electrode body by laying up a first electrode, a separator and a second electrode. As the separator a separator is used that includes a base material layer, and an adhesive layer formed on a surface of the base material layer, with the adhesive layer being configured to have a first adhesive layer region and a second adhesive layer region that is thicker than the first adhesive layer region. The first electrode and the separator are laid up so that the first adhesive layer region and second adhesive layer region oppose the first electrode active material layer.

### CROSS REFERENCE TO RELATED APPLICATION

This application claims the benefit of priority to Japanese Patent Application No. 2022-039649 filed on Mar. 14, 2022. The entire contents of this application are hereby incorporated herein by reference.

### BACKGROUND OF THE DISCLOSURE

### 1. Field

The present disclosure relates to a method for producing a battery.

### 2. Background

A battery is conventionally known which has a wound electrode body resulting from laying up a band-shaped positive electrode provided with a positive electrode active material layer on a positive electrode collector, and a band-shaped negative electrode provided with a negative electrode active material layer on a negative electrode collector, across a band-shaped separator, and from winding the resulting stack in a longitudinal direction. For instance WO 2021/060010 describes a squashed flat-shaped wound electrode body obtained through press molding of a cylindrical electrode body. Further, WO 2021/060010 indicates that multiple electrode tabs at which collectors are exposed are provided on one edge side extending in a longitudinal direction of a band-shaped electrode plate (positive electrode plate and/or negative electrode plate), and the multiple electrodes become stacked through winding, and thereafter the resulting stack is electrically connected to electrode terminals.

### SUMMARY

In such a wound electrode body an active material layer (positive electrode active material layer and/or negative electrode active material layer) becomes readily thinner, on account of coating sagging, in the vicinity of electrode tabs at which a collector is exposed. Also, electrode plates and separators may exhibit waviness (distortion) during, for instance, winding. As a result, the inter-electrode distance between the positive electrode active material layer and the negative electrode active material layer increases locally in the vicinity of electrode tabs. When the inter-electrode distance increases locally, charge transfer resistance increases at the affected site, and a coating film is likely to form. A concern arises in that, as a result, battery reactions and coating film formation within the electrode body may become uneven, and long-term cycle characteristics (capacity retention rate) may decrease. In particular, in a battery configuration such as that disclosed in WO 2021/060010, a wound electrode body is accommodated inside a battery case, with the electrode tabs being in a bent state. In such an implementation, stress arising at the time of bending of the electrode tabs acts on the active material layer in the vicinity of the electrode tabs, and the above-described local increases in inter-electrode distance may become even more pronounced.

The present disclosure has been arrived at in the light of the above considerations and it is an object thereof to provide a method for producing a battery in which increases in inter-electrode distance is curtailed in the vicinity of the electrode tabs.

The present disclosure provides a method for producing a battery that has an electrode body that includes a first electrode, a second electrode, and a separator disposed between the first electrode and the second electrode; and a battery case that accommodates the electrode body, with the first electrode being configured to include a first electrode core body, and a first electrode active material layer formed on the first electrode core body, and have a first active material layer non-formation area at which the first electrode core body is exposed. The production method has an electrode body production step of producing the electrode body by laying up the first electrode, the separator and the second electrode, and an accommodation step of accommodating the electrode body in the battery case. In the electrode body production step, as the separator a separator is used that includes a base material layer, and an adhesive layer formed on at least one surface of the base material layer, the adhesive layer being configured to have a first adhesive layer region and a second adhesive layer region that is thicker than the first adhesive layer region, and the first electrode and the separator are laid up so that the first adhesive layer region and the second adhesive layer region oppose the first electrode active material layer.

In the electrode body production step of the art disclosed herein a separator is used which has an adhesive layer including a first adhesive layer region and a second adhesive layer region of mutually different thickness. The adhesive layer has enough adhesiveness so as to be bonded to the first electrode. In the electrode body production step, therefore, the first adhesive layer region and the second adhesive layer region of the separator deform along the surface of the first electrode, for instance through press molding and drying, and become bonded (for instance pressure-bonded to the first electrode). Herein surface pressure bears readily on a portion, within the first electrode, opposing the relatively thicker second adhesive layer region; as a result, the surface pressure distribution at the time of bonding can be rendered relatively uniform. The separator and the first electrode are firmly bonded to each other in the vicinity of the electrode tabs, and the inter-electrode distance between the positive electrode active material layer and the negative electrode active material layer can be readily maintained uniform, in particular also in the vicinity of the electrode tab, where thickness is likely to be thinner. Therefore, a production method such as the above allows producing a battery in which local increases in inter-electrode distance can be suppressed in the vicinity of the electrode tabs, and in which battery reaction variability is reduced, the battery exhibiting superior long-term cycle characteristics.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective-view diagram illustrating schematically a battery according to an embodiment;

FIG. 2 is a schematic longitudinal cross-sectional diagram along line II-II in FIG. 1;

FIG. 3 is a schematic longitudinal cross-sectional diagram along line in FIG. 1;

FIG. 4 is a schematic transversal cross-sectional diagram along line IV-IV in FIG. 1;

FIG. 5 is a perspective-view diagram illustrating schematically a plurality of wound electrode bodies attached to a sealing plate;

FIG. 6 is a perspective-view diagram illustrating schematically a wound electrode body to which a respective positive electrode second collector and a respective negative electrode second collector are attached;

FIG. 7 is a schematic diagram illustrating the configuration of a wound electrode body;

FIG. 8 is an enlarged-view diagram illustrating schematically an interface between a positive electrode plate, a negative electrode plate and a separator;

FIG. 9 is a plan-view diagram illustrating part of a separator prior to bonding to an electrode plate;

FIG. 10 is a diagram, corresponding to FIG. 8, for explaining a press molding step;

FIG. 11 is a plan-view diagram illustrating a separator according to a first variation;

FIG. 12 is a plan-view diagram illustrating a separator according to a second variation;

FIG. 13 is a plan-view diagram illustrating a separator according to a third variation;

FIG. 14 is a plan-view diagram illustrating a separator according to a fourth variation;

FIG. 15 is a plan-view diagram illustrating a separator according to fifth variation; and

FIG. 16 is a plan-view diagram illustrating a separator according to a sixth variation.

### DETAILED DESCRIPTION OF THE PREFERRED EMBODIMENTS

Some embodiments of the art disclosed herein will be explained next with reference to accompanying drawings. Any features other than the matter specifically set forth in the present specification and that may be necessary for carrying out the present specification (for instance the general configuration and production process of a battery that do not characterize the present disclosure) can be regarded as instances of design matter, for a person skilled in the art, based on known art in the relevant technical field. The art disclosed herein can be implemented on the basis of the disclosure of the present specification and common technical knowledge in the relevant technical field. In the present specification, the notation “A to B” for a range signifies a value “equal to or larger than A and equal to or smaller than B”, and is meant to encompass also the meaning of being “preferably larger than A” and “preferably smaller than B”.

The reference symbol X in the figures of the present specification denotes a “width direction”, the reference symbol Y denotes a “depth direction”, and the reference symbol Z denotes a “height direction”. Further, the reference symbol F in the depth direction X denotes “front” and Rr denotes “rear”. The reference symbol L in the width direction Y denotes “left” and R denotes “right”. The reference symbol U in the height direction Z denotes “up”, and D denotes “down”. These directions are defined however for convenience of explanation, and are not intended to limit the manner in which the battery disclosed herein is installed.

In the present specification the term “battery” is a term denoting power storage devices in general capable of extracting electrical energy, and encompasses conceptually primary batteries and secondary batteries. In the present specification, the term “secondary battery” denotes a power storage device in general that can be repeatedly charged and discharged as a result of the movement of charge carriers across a pair of electrodes (positive electrode and negative electrode) via an electrolyte. Such secondary batteries include not only so-called storage batteries such as lithium ion secondary batteries and nickel-metal hydride batteries, but also capacitors such as electrical double layer capacitors. Embodiments of a lithium ion secondary battery will be explained next.

1. Battery Structure

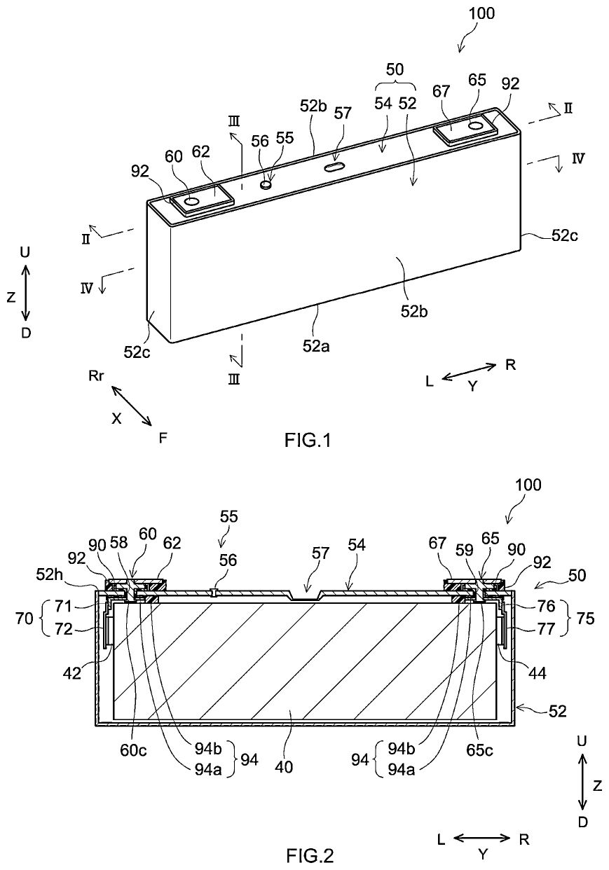

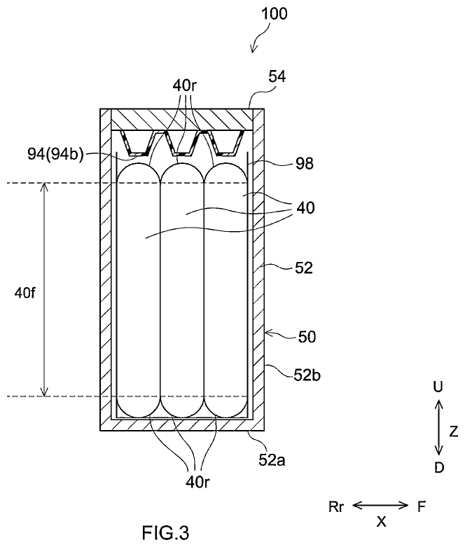

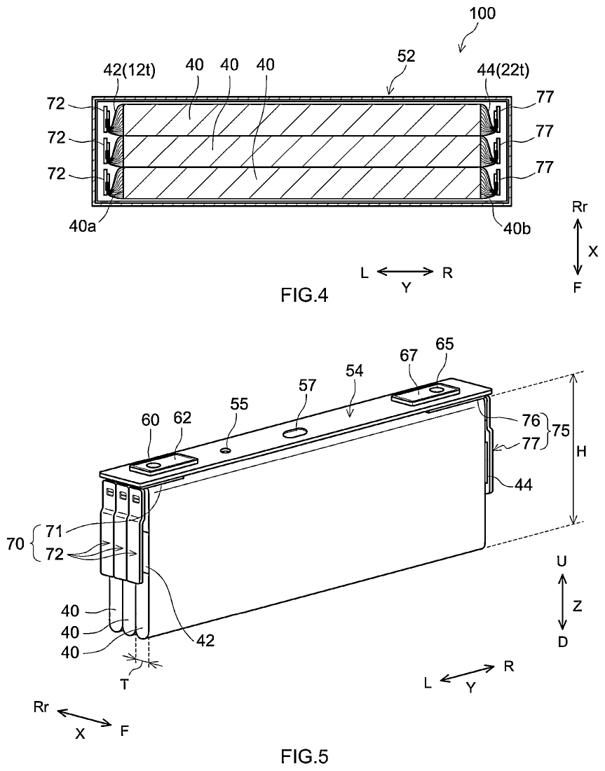

FIG. 1 is a perspective-view diagram illustrating schematically a battery 100 according to the present embodiment. FIG. 2 is a schematic longitudinal cross-sectional diagram along line II-II in FIG. 1. FIG. 3 is a schematic longitudinal cross-sectional diagram along line in FIG. 1. FIG. 4 is a schematic transversal cross-sectional diagram along line IV-IV in FIG. 1.

As illustrated in FIG. 2, the battery 100 according to the present embodiment includes a wound electrode body 40 and a battery case 50 that accommodates the wound electrode body 40. Although not illustrated in the figures, an electrolyte solution is further accommodated in the interior of the battery case 50. A concrete configuration of such a battery 100 will be explained next.

The battery case 50 is a housing that accommodates the wound electrode bodies 40. As illustrated in FIG. 1, the external shape of the battery case 50 in the present embodiment is a flat and bottomed cuboid shape (angular shape). A conventionally known material can be used in the battery case 50, without particular limitations. The battery case 50 may be made of a metal. Examples of the material of the battery case 50 include aluminum, aluminum alloys, iron, iron alloys and the like.

As illustrated in FIG. 1 and FIG. 2, the battery case 50 includes an exterior body 52 and a sealing plate 54. The exterior body 52 is a flat bottomed square container having an opening 52h in the top face. As illustrated in FIG. 1, the exterior body 52 has a planar and substantially rectangular bottom wall 52a, a pair of long side walls 52b extending upward in the height direction Z, from the long sides of the bottom wall 52a, and a pair of short side walls 52c extending upward in the height direction Z, from the short sides of the bottom wall 52a. The sealing plate 54 is a planar and substantially rectangular plate-shaped member that plugs the opening 52h of the exterior body 52. The outer peripheral edge portion of the sealing plate 54 is joined (for instance welded joining) to the outer peripheral edge portion of the opening 52h of the exterior body 52. Accordingly, the interior of the battery case 50 is hermetically sealed. The sealing plate 54 is provided with a liquid injection hole 55 and a gas discharge valve 57. The liquid injection hole 55 is a through-hole provided for the purpose of injecting an electrolyte solution into the sealed battery case 50. The liquid injection hole 55 is sealed with a sealing member 56 after injection of the electrolyte solution. The gas discharge valve 57 is a thin-walled portion designed to break (to open) when a large amount of gas is generated inside the battery case 50, and to discharge that generated gas.

Electrolyte solutions that are utilized in conventionally known batteries can be used, without particular limitations, as the electrolyte solution. For instance a nonaqueous electrolyte solution in which a supporting salt is dissolved in a nonaqueous solvent can be used as the electrolyte solution. Examples of the nonaqueous solvent include carbonate solvents such as ethylene carbonate, dimethyl carbonate and ethyl methyl carbonate. Examples of the supporting salt include fluorine-containing lithium salts such as LiPF₆.

A positive electrode terminal 60 is attached to one end (left side in FIG. 1 and FIG. 2) of the sealing plate 54 in the width direction Y. The positive electrode terminal 60 is connected to a plate-shaped positive electrode external conductive member 62, on the outside of the battery case 50. A negative electrode terminal 65 is attached to the other end (right side in FIG. 1 and FIG. 2) of the sealing plate 54 in the width direction Y. A plate-shaped negative electrode external conductive member 67 is attached to the negative electrode terminal 65. The positive electrode external conductive member 62 and negative electrode external conductive member 67 are connected to other batteries and external devices via an external connecting member (bus bar or the like).

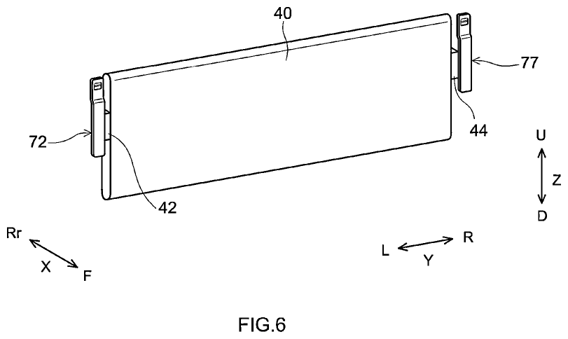

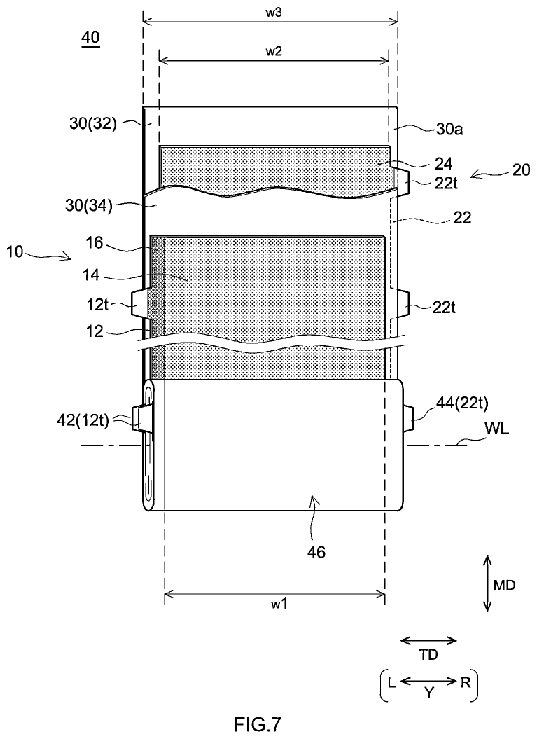

FIG. 5 is a perspective-view diagram illustrating schematically a plurality of wound electrode bodies 40 attached to the sealing plate 54. In the battery 100 according to the present embodiment, a plurality (more specifically, three) of wound electrode bodies 40 are accommodated in the battery case 50, as illustrated in FIG. 3 to FIG. 5. Although the detailed structure thereof will be described further on, each wound electrode body 40 has a positive electrode tab group 42 and a negative electrode tab group 44 (see also FIG. 6 and FIG. 7).

As illustrated in FIG. 4, the electrode tab groups (positive electrode tab group 42 and negative electrode tab group 44) are bent in a state of being joined to the electrode collectors (positive electrode collector 70 and negative electrode collector 75. Each positive electrode tab group 42 of the plurality of wound electrode bodies 40 is connected to the positive electrode terminal 60 via the positive electrode collector 70. The positive electrode collector 70 is accommodated inside the battery case 50. As illustrated in FIG. 2 and FIG. 5, the positive electrode collector 70 has a positive electrode first collector 71 which is a plate-shaped conductive member extending, in the width direction Y, along the inner surface of the sealing plate 54, and a plurality of positive electrode second collectors 72 which are plate-shaped conductive member extending in the height direction Z. A lower end portion 60c of the positive electrode terminal 60 is inserted into the battery case 50 through a terminal insertion hole 58 of the sealing plate 54, and is connected to the positive electrode first collector 71 (see FIG. 2). The positive electrode second collectors 72 are connected to respective positive electrode tab groups 42 of the wound electrode bodies 40. As illustrated in FIG. 4 and FIG. 5, the positive electrode tab groups 42 are bent so that the positive electrode second collectors 72 and one side face 40a of the wound electrode bodies 40 oppose each other. The upper end portion of the positive electrode second collectors 72 and the positive electrode first collector 71 become electrically connected to each other as a result.

Moreover, each negative electrode tab group 44 of the plurality of wound electrode bodies 40 is connected to the negative electrode terminal 65 via the negative electrode collector 75. Here, the connection structure on the negative electrode side is substantially identical to the connection structure on the positive electrode side described above. Specifically, as illustrated in FIG. 2 and FIG. 5, the negative electrode collector 75 has a negative electrode first collector 76 which is a plate-shaped conductive member extending in the width direction Y along the inner surface of the sealing plate 54, and a plurality of negative electrode second collectors 77 which are plate-shaped conductive member extending in the height direction Z. A lower end portion 65c of the negative electrode terminal 65 is inserted into the battery case 50 through a terminal insertion hole 59, to be connected to the negative electrode first collector 76 (see FIG. 2). Each of the plurality of negative electrode second collectors 77 is connected to a respective negative electrode tab group 44. As illustrated in FIG. 4 to FIG. 5, the negative electrode tab group 44 is bent so that the negative electrode second collectors 77 and the other side face 40b of the wound electrode bodies 40 oppose each other. The upper end portion of the negative electrode second collectors 77 and the negative electrode first collector 76 become electrically connected to each other as a result. A metal having excellent conductivity (aluminum, aluminum alloy, copper, copper alloy or the like) can be suitably used as the electrode collectors (positive electrode collector 70 and negative electrode collector 75).

In the battery 100 various insulating members are further attached in order to prevent conduction between the wound electrode bodies 40 and the battery case 50. Specifically, a respective external insulating member 92 is interposed between the positive electrode external conductive member 62 (negative electrode external conductive member 67) and the outer surface of the sealing plate 54 (see FIG. 1 and FIG. 2). As a result it becomes possible to prevent conduction between the positive electrode external conductive member 62 or the negative electrode external conductive member 67 and the sealing plate 54. A respective gasket 90 is fitted to each of the terminal insertion holes 58, 59 of the sealing plate 54 (see FIG. 2). As a result it becomes possible to prevent conduction between the positive electrode terminal 60 (or negative electrode terminal 65), inserted into the terminal insertion holes 58, 59, and the sealing plate 54.

Further, a respective internal insulating member 94 is disposed between the positive electrode first collector 71 (or the negative electrode first collector 76) and the inner surface of the sealing plate 54. The internal insulating member 94 includes a plate-shaped base portion 94a interposed between the positive electrode first collector 71 (or the negative electrode first collector 76) and the inner side surface of the sealing plate 54. As a result it becomes possible to prevent conduction between the positive electrode first collector 71 or the negative electrode first collector 76 and the sealing plate 54. Each internal insulating member 94 is further provided with a protruding portion 94b that protrudes from the inner surface of the sealing plate 54 towards the wound electrode bodies 40 (see FIG. 2 and FIG. 3). As a result it becomes possible to restrict the movement of the wound electrode bodies 40 in the height direction Z, and to prevent direct contact between the wound electrode bodies 40 and the sealing plate 54.

In addition, the plurality of wound electrode bodies 40 are accommodated inside the battery case 50 in a state of being covered with an electrode body holder 98 (see FIG. 3) made up of an insulating resin sheet. This allows preventing as a result direct contact between the wound electrode bodies 40 and the exterior body 52. The material of each of the above-described insulating members is not particularly limited, so long as the material has predetermined insulating properties. As an example, there can be used synthetic resin materials, for instance polyolefin resins such as polypropylene (PP) and polyethylene (PE), as well as fluororesins such as perfluoroalkoxyalkanes and polytetrafluoroethylene (PTFE).

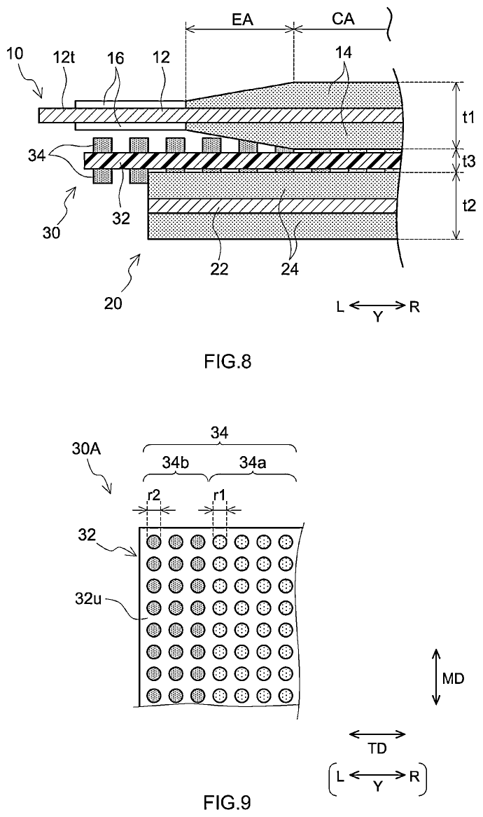

FIG. 6 is a perspective-view diagram illustrating schematically a wound electrode body 40 to which a respective positive electrode second collector 72 and a respective negative electrode second collector 77 are attached. FIG. 7 is a schematic diagram illustrating the configuration of a wound electrode body 40. FIG. 8 is an enlarged-view diagram illustrating schematically an interface between a positive electrode plate 10, the negative electrode plate 20, and a separator 30 in the vicinity of the left end portion of the wound electrode body 40. FIG. 8 illustrates a state in which the positive electrode plate 10 and the separator 30 are bonded together, and the negative electrode plate 20 and the separator 30 are bonded together. FIG. 7 and so forth the reference symbol MD signifies a longitudinal direction (i.e. transport direction) and a machine direction with regard to the wound electrode body 40 and the separator 30 produced in a band shape. Further, the reference symbol TD signifies a direction perpendicular to the “MD direction” and indicates herein a “width direction” (transverse direction). The “TD direction” is the same direction as that denoted the reference symbol Y (width direction) above.

As illustrated in FIG. 7, the electrode body used in the battery 100 is a wound electrode body 40 that results from laying up a band-shaped positive electrode plate 10 and a band-shaped negative electrode plate 20 across a band-shaped separator 30, and by winding the resulting stack about a winding axis WL. However, in other embodiments the electrode body may be a multilayer electrode body in which a rectangular positive electrode and a rectangular negative electrode are laid up on each other across a rectangular separator. In that case, the separator 30 may be folded in zig-zag folds. The positive electrode plate 10 is an example of a “first electrode”, and the negative electrode plate 20 is an example of a “second electrode”. However, in other embodiments the negative electrode plate 20 may be the “first electrode” and the positive electrode plate 10 may be the “second electrode”.

The wound electrode body 40 has herein a flat external shape. Such a flat-shaped wound electrode body 40 can be formed for instance by press molding of an electrode body wound to a cylindrical shape. However, in other embodiments the electrode body may be for instance tubular in shape. As illustrated in FIG. 3, the flat-shaped wound electrode body 40 has a pair of curved portions 40r having curved outer surfaces, and a flat portion 40f having a flat outer surface and that connects the pair of curved portions 40r. As illustrated in FIG. 2, in the battery 100 the wound electrode bodies 40 are accommodated in the battery case 50 in such a manner that the winding axis WL and the width direction Y of the battery 100 substantially match each other.

A thickness T (see FIG. 5) of the wound electrode body 40 is preferably 8 mm or larger, and is more preferably from 8 to 25 mm, yet more preferably from 8 to 20 mm, and particularly preferably from 10 to 15 mm. The term “thickness T of the wound electrode body 40” denotes the length (average length) of the flat portion 40f in a direction perpendicular to the flat portion 40f. A height H (see FIG. 5) of the wound electrode body 40 is preferably 120 mm or smaller, and is more preferably from 60 to 120 mm, yet more preferably from 80 to 110 mm, and particularly preferably from 90 to 100 mm. The “height H of the wound electrode body 40” denotes the length (average length) from an upper end of given one of curved portions 40r to a lower end of the other curved portions 40r.

As described above, each wound electrode body 40 is accommodated inside the battery case 50 in a state where the electrode tab groups (the positive electrode tab group 42 and the negative electrode tab group 44) are bent. As a result, the width of the wound electrode body 40 can be increased up to a position close to the inner wall of the battery case 50, which can significantly contribute to enhance battery performance. Normally, stress arising upon bending of the electrode tab group acts on the flat portion 40f positioned in the vicinity of the electrode tab group. Therefore, the inter-electrode distance readily increases locally in the flat portion 40f positioned in the vicinity of the electrode tab group. By contrast, the battery 100 has a configuration that allows suitably suppressing increases in inter-electrode distance even upon bending of the electrode tab groups of the wound electrode body 40. A concrete configuration of the wound electrode body 40 according to the present embodiment will be explained below.

The positive electrode plate 10 is a band-shaped member, as illustrated in FIG. 7. The positive electrode plate 10 includes a band-shaped positive electrode core body 12 and a positive electrode active material layer 14 applied on the positive electrode core body 12. In the present embodiment the positive electrode core body 12 is an example of a “first electrode core body”, and the positive electrode active material layer 14 is an example of a “first electrode active material layer”. The positive electrode active material layer 14 is preferably formed on both faces of the positive electrode core body 12, from the viewpoint of battery performance. In the positive electrode plate 10, positive electrode tabs 12t protrude outward (towards the left in FIG. 7) from one edge in the width direction TD. The positive electrode tabs 12t are provided as a plurality thereof at predetermined intervals in the longitudinal direction MD. The positive electrode tabs 12t are regions at which the positive electrode active material layer 14 is not formed, and the positive electrode core body 12 is exposed. A protective layer 16 is formed as a band shape along the longitudinal direction MD of the positive electrode plate 10, in a region adjacent to an edge of the positive electrode plate 10, on the side of the positive electrode tabs 12t. The portion where the positive electrode tabs 12t and the protective layer 16 are formed is an example of the “first active material layer non-formation area”. However, in other embodiments the “first active material layer non-formation area” may be provided between the positive electrode tabs 12t and the positive electrode active material layer 14 in the width direction TD, and may be a band-shaped positive electrode uncoated portion at which the positive electrode core body 12 is exposed.

Conventionally known materials that can be used in batteries in general (for instance in lithium ion secondary batteries) can be utilized, without particular limitations, in the members that make up the positive electrode plate 10. For instance a metallic foil having a predetermined conductivity can be preferably used in the positive electrode core body 12. Preferably, the positive electrode core body 12 is for instance made up of aluminum or an aluminum alloy.

The positive electrode active material layer 14 contains a positive electrode active material. The positive electrode active material is a particulate material capable of reversibly storing and releasing charge carriers. A lithium-transition metal complex oxide is suitable herein as the positive electrode active material, from the viewpoint of stably producing a high-performance positive electrode plate 10. Particularly suitable among the foregoing is a lithium-transition metal complex oxide that contains, as a transition metal, at least one selected from the group consisting of nickel (Ni), cobalt (Co) and manganese (Mn). Concrete examples include lithium-nickel-cobalt-manganese-based complex oxides (NCMs), lithium-nickel-based complex oxides, lithium-cobalt-based complex oxides, lithium-manganese-based complex oxides, lithium-nickel-manganese-based complex oxides, lithium-nickel-cobalt-aluminum-based complex oxides (NCAs), and lithium-iron-nickel-manganese-based-based complex oxides. Preferable examples of lithium-transition metal-based complex oxides not containing Ni, Co and Mn include lithium iron phosphate-based complex oxides (LFPs).

The term “lithium-nickel-cobalt-manganese complex oxide” encompasses oxides that contain an additional element, besides a main constituent element (Li, Ni, Co, Mn and O).

Examples of such additional elements include transition metal elements and main-group metal elements such as Mg, Ca, Al, Ti, V, Cr, Si, Y, Zr, Nb, Mo, Hf, Ta, W, Na, Fe, Zn or Sn. The additional element may be a metalloid element such as B, C, Si or P, or a non-metal element such as S, F, Cl, Br or I. The same applies to other lithium transition metal-based complex oxides notated as “-based complex oxides”.

The positive electrode active material layer 14 may contain additives other than the positive electrode active material. Examples of such additives include conductive materials and binders. Concrete examples of the conductive material include carbon materials such as acetylene black (AB). Concrete examples of the binder include resin binders such as polyvinylidene fluoride (PVdF). The content of the positive electrode active material relative to 100 mass % as the total solids of the positive electrode active material layer 14 is about 80 mass % or higher, and typically 90 mass % or higher.

The surface roughness Ra of the positive electrode active material layer 14 is preferably 0.01 μm or higher, and more preferably 0.02 μm or higher. When the surface of the positive electrode active material layer 14 has fine irregularities, an adhesive layer 34 of the separator 30 bites into the surface of the positive electrode active material layer 14 on account of an anchor effect, as illustrated in FIG. 8, and the positive electrode plate 10 and the separator 30 become readily bonded to each other. The surface roughness Ra of the positive electrode active material layer 14 may be for instance 3 μm or smaller. The term “surface roughness” denotes arithmetic mean roughness.

Preferably, the positive electrode active material layer 14 includes large positive electrode active material particles having a peak particle size in the range from 10 μm to 20 μm, and small positive electrode active material particles having a peak particle size in the range from 2 μm to 6 μm, in a particle size distribution analyzed by laser diffraction/scattering. The large positive electrode active material particles and the small positive electrode active material particles may be of a same type of lithium-transition metal complex oxide, or may be of different types of lithium-transition metal complex oxide. By mixing thus two types of positive electrode active material particles having different particle sizes, fine irregularities such as those described above become readily formed on the surface of the positive electrode active material layer 14.

A width w1 (see FIG. 7) of the positive electrode active material layer 14 is preferably 20 cm or larger. A greater width w1 of the positive electrode active material layer 14 entails a larger wound electrode body 40; the elastic action generated from the curved portions 40r after press molding increases as a result. As a result, springback in which the flat portion 40f expands on account of the residual elastic action of the curved portions 40r is likely to occur, and the inter-electrode distance tends to increase. The art disclosed herein allows suitably suppressing not only increases in inter-electrode distance derived from bending of the positive electrode tabs 12t, but also increases in inter-electrode distance caused by springback. Therefore, battery reaction variability is suppressed also in a case where the width w1 of the positive electrode active material layer 14 is 20 cm or larger. The width w1 is more preferably from 20 to 40 cm, and yet more preferably from 25 to 35 cm. The term “width w1 of the positive electrode active material layer 14” denotes the length (average length) of the positive electrode active material layer 14 in the width direction TD of the wound electrode body 40.

As illustrated in FIG. 8, the positive electrode active material layer 14 includes an end area EA being an end portion, of non-uniform thickness, close to the positive electrode tabs 12t and the protective layer 16, in the width direction Y, and a central area CA of substantially uniform thickness, positioned closer to the center than the end area EA. The end area EA is a region lying within 40 mm, for instance within 2 to 30 mm, in the width direction Y, from the boundary with the active material layer non-formation area. The thickness of the positive electrode active material layer 14 in the end area EA is smaller than the thickness of the positive electrode active material layer 14 in the central area CA. In the end area EA the thickness of the positive electrode active material layer 14 decreases gradually towards the positive electrode tabs 12t (and towards the protective layer 16).

In the central area CA an overall thickness t1 (see FIG. 8) of the positive electrode plate 10 is preferably 80 μm or larger, more preferably 100 μm or larger, and yet more preferably 120 μm or larger. Similarly to the case where the width w1 is wide, the elastic action after press molding becomes larger, and inter-electrode distance can increase readily, when the thickness t1 is large; however, the art disclosed herein allows suitably suppressing also increases in inter-electrode distance derived from springback. From the viewpoint of facilitating prevention of springback, the overall thickness t1 is preferably 200 μm or smaller, more preferably 180 μm or smaller, and yet more preferably 160 μm or smaller. The term “overall thickness of the positive electrode plate 10” denotes the total of the thickness (average thickness) of the positive electrode core body 12 and the positive electrode active material layer 14 in the central area CA.

The protective layer 16 is a layer configured to have lower electrical conductivity than that of the positive electrode active material layer 14. The protective layer 16 is provided in a region adjacent to an edge of the positive electrode plate 10. As a result, it becomes possible to prevent internal short circuits caused by direct contact between the positive electrode core body 12 and the negative electrode active material layer 24 when the separator 30 is damaged. Preferably, the protective layer 16 contains insulating ceramic particles. Examples of ceramic particles include inorganic oxides such as alumina (Al₂O₃), magnesia (MgO), silica (SiO₂) and titania (TiO₂); nitrides such as aluminum nitride and silicon nitride; metal hydroxides such as calcium hydroxide, magnesium hydroxide and aluminum hydroxide; clay minerals such as mica, talc, boehmite, zeolite, apatite and kaolin; and glass fibers. Alumina, boehmite, aluminum hydroxide, silica and titania are preferable, among the foregoing, in terms of insulating properties and heat resistance. The protective layer 16 may contain a binder for fixing the ceramic particles to the surface of the positive electrode core body 12. Examples of such binders include resin binders such as polyvinylidene fluoride (PVdF). The protective layer is however not an essential constituent element of the positive electrode plate 10. In other embodiments there may be used a positive electrode plate having no protective layer 16 formed thereon.

The negative electrode plate 20 is a band-shaped member, as illustrated in FIG. 7. The negative electrode plate 20 includes a band-shaped negative electrode core body 22 and a negative electrode active material layer 24 applied on the negative electrode core body 22. The negative electrode core body 22 is an example of a “second electrode core body”, and the negative electrode active material layer 24 is an example of a “second electrode active material layer”. Preferably, the negative electrode active material layer 24 is formed on both faces of the negative electrode core body 22, in terms of battery performance. In the negative electrode plate 20, negative electrode tabs 22t protrude outward (towards the right in FIG. 7) from one edge in the width direction TD. The negative electrode tabs 22t are provided as a plurality thereof at predetermined intervals in the longitudinal direction MD. The negative electrode tabs 22t are regions at which the negative electrode active material layer 24 is not formed, and the negative electrode core body 22 is exposed. The negative electrode tabs 22t are an example of a “second active material layer non-formation area”. However, in other embodiments the “second active material layer non-formation area” may be provided between the negative electrode tabs 22t and the negative electrode active material layer 24 in the width direction TD, and may be a band-shaped uncoated portion in which the negative electrode core body 22 is exposed.

Conventionally known materials that can be used in batteries in general (for instance in lithium ion secondary batteries) can be utilized herein, without particular limitations, in the members that make up the negative electrode plate 20. For instance a metallic foil having a predetermined conductivity can be preferably used in the negative electrode core body 22. Preferably, the negative electrode core body 22 is for instance made up of copper or a copper alloy.

The negative electrode active material layer 24 contains a negative electrode active material. The negative electrode active material is not particularly limited, so long as it is capable of reversibly storing and releasing charge carriers, in a relationship with the positive electrode active material described above, and materials that can be used in conventional ordinary batteries can be used herein without particular limitations. Examples of negative electrode active materials include carbon materials and silicon-based materials. Examples of carbon materials that can be used include graphite, hard carbon, soft carbon and amorphous carbon.

The negative electrode active material layer 24 may contain additives other than the negative electrode active material. Examples of such additives include binders and thickeners. Concrete examples of the binder include rubber-based binders such as styrene-butadiene rubber (SBR). Concrete examples of thickeners include carboxymethyl cellulose (CMC). The content of the negative electrode active material is about 30 mass % or higher, and can typically be 50 mass % or higher, relative to 100 mass % as the total solids of the negative electrode active material layer 24. The negative electrode active material may take up 80 mass % or more, or 90 mass % or more, of the negative electrode active material layer 24.

Similarly to the surface roughness Ra of the positive electrode active material layer 14 described above, the surface roughness Ra of the negative electrode active material layer 24 is preferably 0.05 μm or larger, and more preferably 0.1 μm or larger, from the viewpoint of eliciting suitable bonding between the negative electrode plate 20 and the separator 30. The upper limit of the surface roughness Ra of the negative electrode active material layer 24 may be for instance 5 μm or less. A width w2 (see FIG. 7) of the negative electrode active material layer 24 is preferably from 20 to 45 cm, more preferably from 25 to 35 cm, in a relationship with the width of the positive electrode active material layer 14 described above. The negative electrode active material layer 24 covers the positive electrode active material layer 14 at both ends in the width direction Y.

The overall thickness t2 (see FIG. 8) of the negative electrode plate 20 is preferably 100 μm or larger, more preferably 130 μm or larger, and yet more preferably 160 μm or larger. As is the case in the positive electrode plate 10 described above, the elastic action after press molding becomes larger, and inter-electrode distance can increase readily, when the thickness t2 increases; however, the art disclosed herein allows suitably suppressing increases in inter-electrode distance caused by springback. The overall thickness t2 is preferably 250 μm or smaller, more preferably 220 μm or smaller, and yet more preferably 190 μm or smaller, from the viewpoint of readily preventing springback. The “overall thickness of the negative electrode plate 20” denotes the total of the thickness (average thickness) of the negative electrode core body 22 and the negative electrode active material layer 24 in the region where the negative electrode active material layer 24 is formed.

Each separator 30 is a band-shaped member, as illustrated in FIG. 7. Two separators 30 are used in one wound electrode body 40. Each separator 30 is an insulating sheet having formed therein a plurality of fine through-holes through which charge carriers can pass. Through interposition of the separators 30 between the positive electrode plate 10 and the negative electrode plate 20 it becomes possible to prevent contact between the positive electrode plate 10 and the negative electrode plate 20, and movement of charge carriers (for instance lithium ions) between the positive electrode plate 10 and the negative electrode plate 20.

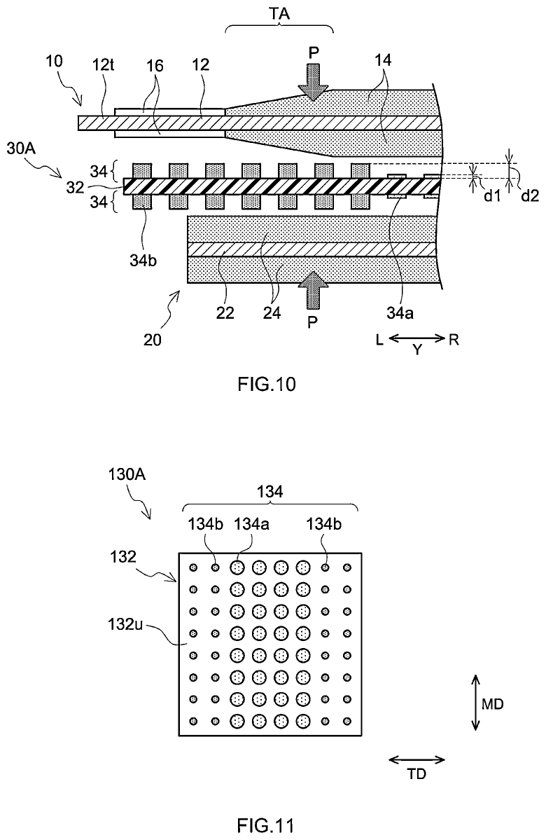

The separator 30 has a band-shaped base material layer 32 and the adhesive layer 34 formed on one or both sides of the base material layer 32. As illustrated in FIG. 8, in the present embodiment a respective adhesive layer 34 is formed on either face of the base material layer 32. In the wound electrode body 40, therefore, the adhesive layer 34 formed on one surface of the separator 30 and the positive electrode plate 10 are bonded together, and the adhesive layer 34 formed on the other surface of the separator 30 and the negative electrode plate 20 are bonded together. As a result there are suppressed local increases in inter-electrode distance in the vicinity of the electrode tab groups (positive electrode tab group 42 and negative electrode tab group 44). Likewise, the flat portion 40f of the wound electrode body 40 is prevented from expanding in the thickness direction (depth direction X), so that also increases in inter-electrode distance caused by springback can be suppressed. The separator 30 having such a configuration will be explained below. The properties and so forth of a separator 30A (see FIG. 9 and FIG. 10) prior to production of the wound electrode body 40 will be described in detail in the production method section.

Base material layers used in conventionally known battery separators can be used herein, without particular limitations, as the base material layer 32. The base material layer 32 is preferably a porous sheet-shaped member. The base material layer 32 may have a single-layer structure, or may have a structure of two or more layers, for instance a three-layer structure. Preferably, the base material layer 32 is made up of a polyolefin resin. As a result, the flexibility of the separators 30 can be sufficiently ensured, and the wound electrode bodies 40 can be easily achieved (wound and press molded). The polyolefin resin is preferably made up of polyethylene (PE), polypropylene (PP) or a mixture thereof, and is more preferably made up of PE. The thickness of the base material layer 32 is preferably from 3 to 25 μm, more preferably from 3 to 18 μm, and yet more preferably from 5 to 14 μm. The air permeability of the base material layer 32 is preferably from 30 to 500 sec/100 cc, more preferably from 30 to 300 sec/100 cc, and yet more preferably from 50 to 200 sec/100 cc.

The adhesive layer 34 may be provided on at least one surface of the base material layer 32. The adhesive layer 34 may be provided directly on the surface of the base material layer 32, or may be provided on the base material layer 32 via another layer. For instance a heat-resistant layer (not shown) may be provided on one or both sides of the base material layer 32, with the adhesive layer 34 being in turn provided on the heat-resistant layer. As illustrated in FIG. 8, in the present embodiment the adhesive layer 34 is squashed, and bites into the surfaces of the positive electrode active material layer 14 and the negative electrode active material layer 24. An anchor effect is elicited as a result, and the positive electrode plate 10 and the separator 30 become firmly integrated with each other, and likewise the negative electrode plate 20 and the separator 30 become firmly integrated with each other.

The adhesive layer 34 contains adhesive particles (binder particles). The adhesive particles may melt partly or wholly in the interior of the battery 100, due to the influence of for instance press molding or a drying treatment, and need not retain their particle shape. As the adhesive particles there may be used, without particular limitations, one or two or more conventionally known resin materials exhibiting a certain viscosity with respect to the electrode plate (positive electrode plate 10 and/or negative electrode plate 20). Concrete examples include resin particles such as of fluororesins, acrylic resins, urethane resins, ethylene vinyl acetate resins and epoxy resins. Polyvinylidene fluoride (PVdF), polytetrafluoroethylene (PTFE) or the like can be used as the fluororesin. Among the foregoing PVdF is particularly preferable, since PVdF exhibits high flexibility and can bring out more suitably adhesiveness towards the electrode plates. The adhesive layer 34 preferably contains, as adhesive particles, the same resin material as the binder contained in the electrode active material layer of the opposing electrode plate. As an example, in a case where the positive electrode active material layer 14 contains PVdF, the adhesive layer 34 that opposes the positive electrode active material layer 14 preferably contains PVdF as adhesive particles. The adhesive strength between the adhesive layer 34 and the positive electrode plate 10 can be further improved as a result.

The adhesive layer 34 may further contain other materials (for instance inorganic particles). Examples of the inorganic particles include ceramic particles of alumina, boehmite, aluminum hydroxide, silica, titania or the like. Preferably, the content (mass ratio) of the adhesive particles in the adhesive layer 34 is the highest, so that there is elicited predetermined adhesiveness towards the electrode plate (positive electrode plate 10 and/or negative electrode plate 20). Through the use of the adhesive particles as a first component of highest content, the separator 30 deforms readily during press molding, and as a result the effect of the art disclosed herein can be brought out at a higher level.

A heat-resistant layer that may be interposed between the base material layer 32 and the adhesive layer 34 typically contains ceramic particles and a binder. Heat shrinkage of the separator 30 can be suppressed, and the safety of the battery 100 can be improved, by providing the heat-resistant layer. The resin materials described above as a constituent material of the adhesive layer 34 can be appropriately used herein as the binder. Fluororesins are preferred among the foregoing. Ceramic particles such as those described above can be appropriately used as the inorganic particles. Alumina particles or boehmite particles are preferred among the foregoing, from the viewpoint of suppressing heat shrinkage in the separator 30. In the heat-resistant layer the mixing ratio (mass ratio) of the inorganic particles and the binder is ranges preferably from 98:2 to 50:50, and more preferably from 95:5 to 70:30. Heat shrinkage of the base material layer 32 is suppressed by prescribing the content of the inorganic particles to be not smaller than a predetermined amount.

A width w3 (see FIG. 7) of each separator 30 is longer than the width w2 of the negative electrode active material layer 24. The separator 30 covers the negative electrode active material layer 24 at both ends in the width direction Y. The width w1 of the positive electrode active material layer 14, the width w2 of the negative electrode active material layer 24, and the width w3 of the separator satisfy a relationship w1<w2<w3. The width w3 of the separator 30 is substantially identical to the width of the wound electrode body 40. Therefore, the width of the wound electrode body 40 can be roughly determined by the width w1 of the positive electrode active material layer 14.

An overall thickness t3 (see FIG. 8) of the separator 30 is preferably 4 μm or larger, more preferably 8 μm or larger, and yet more preferably 12 μm or larger. As is the case in the positive electrode plate 10 and the negative electrode plate 20 described above, the elastic action after press molding becomes larger, and inter-electrode distance can increase readily, when the overall thickness t3 increases; however, the art disclosed herein allows suitably suppressing increases in inter-electrode distance caused by springback. The overall thickness t3 of the separator 30 is preferably 28 μm or smaller, more preferably 24 μm or smaller, and yet more preferably 20 μm or smaller, from the viewpoint of preventing springback more readily. The term “overall thickness t3 of the separator 30” denotes the total of the thickness (average thickness) of the base material layer 32 and the adhesive layer 34.

2. Battery Production Method

The battery 100 can be produced in accordance with a production method that includes: (1) an electrode body production step and (2) an accommodation step, in this order. The method for producing the battery 100 is characterized by the use of the separator 30, described in detail below. The production process may be otherwise similar to conventional ones. In addition, the production method disclosed herein may further include other steps, at any stage.

(1) The electrode body production step is a step of stacking the positive electrode plate 10 and the negative electrode plate 20 across a separator 30 interposed therebetween, to produce a respective wound electrode body 40. (1) The electrode body production step typically includes: (1-1) a separator preparation step, (1-2) a winding step, and (1-3) a press molding step, in this order. However, the press molding step (1-3) is not essential, and can be omitted. A drying treatment step may be included after the winding step (1-2) or the press molding step (1-3).

In the separator preparation step (1-1) there is prepared a separator having the band-shaped base material layer 32, and the adhesive layer 34 formed on at least one surface of the base material layer 32. FIG. 9 is a plan-view diagram illustrating part of the separator 30A prior to preparation of a respective wound electrode body 40 (in other words, prior to bonding to an electrode plate (positive electrode plate 10 and/or negative electrode plate 20)). As FIG. 8 and so forth depicts, the separator 30A has the adhesive layer 34 (specifically, a first adhesive layer region 34a and a second adhesive layer region 34b described below) on both faces (front and back) of the base material layer 32. The base material layer 32 is preferably made up of a material (for instance a polyolefin resin) and is formed to thickness such as those described above.

The adhesive layer 34 is preferably made up of a material such as those described above. The adhesive layer 34 preferably contains for instance a fluororesin. As illustrated in FIG. 9, the adhesive layer 34 has, on one surface 32u, a first adhesive layer region 34a and a second adhesive layer region 34b that is thicker than the first adhesive layer region 34a. The surface 32u is the surface opposing the positive electrode plate 10. The first adhesive layer region 34a and the second adhesive layer region 34b provided on the surface 32u both are sites opposing the positive electrode plate 10 in a below-described winding step. The first adhesive layer region 34a and the second adhesive layer region 34b extend in the form of bands along the longitudinal direction MD of the separator 30A. The first adhesive layer region 34a is provided so as to oppose a tab vicinity area TA (see FIG. 10), of the positive electrode active material layer 14, that includes at least part of the end area EA, and also includes an end portion of the positive electrode active material layer 14 on the side of the positive electrode tabs 12t, and a region of at least 10 mm from that end portion, in the width direction Y. The tab vicinity area TA is an example of a “region adjacent to a first active material layer non-formation area of the first electrode active material layer”. The second adhesive layer region 34b is formed so as to oppose a region (mainly the central area CA) of the positive electrode active material layer 14 other than the tab vicinity area.

Preferably, the first adhesive layer region 34a and the second adhesive layer region 34b are each made up of one or two or more (plurality of) adhesive particles (for instance resin particles) in turn made of a material such as those described above. The adhesive particles may be substantially spherical, or may be fibrous, plate-like, amorphous or the like. The adhesive particles may form aggregates, and may swell in the electrolyte solution, with particle boundaries becoming indefinite as a result. By incorporating thus the adhesive particles it becomes possible to impart suitable flexibility to the adhesive layer 34, which facilitates deformation of the adhesive layer 34 so as to be squashed during the below-described press molding. Variability in inter-electrode distance in the wound electrode body 40 can be suitably absorbed as a result. Among the foregoing, the second adhesive layer region 34b is preferably made up of a plurality of adhesive particles. The multiple adhesive particles may be laid up in the thickness direction. Also, the multiple adhesive particles (for instance resin particles) may be of different types. The adhesive particles break apart by being squashed in the below-described press molding step. Increases in inter-electrode distance in the tab vicinity area TA can be more suitably suppressed thereby.

The thicknesses of the first adhesive layer region 34a and the second adhesive layer region 34b can be adjusted for instance by prescribing dissimilar numbers of adhesive particles laid up in the thickness direction. A thickness d1 (see FIG. 10) of the first adhesive layer region 34a is preferably from 0.1 to 3.0 μm, more preferably from 0.4 to 1.5 μm. A thickness d2 (see FIG. 10) of the second adhesive layer region 34b is preferably from 0.5 to 8.0 μm, more preferably from 1.0 to 3.5 μm. A difference (d2−d1) between the thickness d2 and the thickness d1 is preferably from 0.5 to 7.9 μm, more preferably from 0.5 to 3.5 μm. A ratio (d2/d1) of the thickness d2 relative to the thickness d1 ranges preferably from 1.5 to 80, more preferably from 2 to 5. The effect of the art disclosed herein can be brought out stably as a result at a higher level.

A ratio of formation surface areas of the first adhesive layer region 34a and the second adhesive layer region 34b in a plan view (formation surface area of the second adhesive layer region 34b/(formation surface area of the second adhesive layer region 34b+formation surface area for the first adhesive layer region 34a)) ranges preferably from 0.000001 to 0.95, more preferably from 0.001 to 0.75. Basis weights of the first adhesive layer region 34a and the second adhesive layer region 34b are preferably from 0.005 to 1.0 g/m², more preferably from 0.02 to 0.04 g/m². The effect of the art disclosed herein can be brought out as a result at a higher level.

The second adhesive layer region 34b is formed to a dotted shape in a plan view. The first adhesive layer region 34a and the second adhesive layer region 34b are each formed to a dotted shape. The permeability of the electrolyte solution into the wound electrode body 40 can be improved as a result. A size r1 of the dots that make up the first adhesive layer region 34a is preferably from 0.05 to 20 mm, more preferably from 0.05 to 10 mm, and yet more preferably from 0.2 to 2.0 mm. A size r2 of the dots that make up the second adhesive layer region 34b is preferably from 0.01 to 20 mm, more preferably from 0.01 to 10 mm, and yet more preferably from 0.1 to 2.0 mm. The effect of the art disclosed herein can be brought out as a result at a higher level. The size of the dots denotes herein the diameter of the dots.

A ratio (r2/r1) of the size r2 relative to the size r1 ranges preferably from 0.2 to 200, more preferably from 0.2 to 3. A difference (r2−r1) between the size r2 and the size r1 is preferably from 0.00 to 9.99 mm, more preferably from 0 to 0.9 mm. The size r1 and the size r2 are herein substantially identical. However, in other embodiments the size r1 and the size r2 may be different from each other. In the first adhesive layer region 34a and the second adhesive layer region 34b the dots are disposed at equal intervals. The spacing between dots in the first adhesive layer region 34a is preferably from 0.2 to 100.0 mm, more preferably from 0.2 to 20.0 mm. The spacing between dots in the second adhesive layer region 34b is preferably from 0.2 to 100.0 mm, more preferably from 0.2 to 20.0 mm. The spacing between the dots is herein substantially the same in the first adhesive layer region 34a and the second adhesive layer region 34b. However, in other embodiments the spacing between the dots may be mutually different.

The elastic modulus of the second adhesive layer region 34b is preferably higher than the elastic modulus of the first adhesive layer region 34a. As a result, the tab vicinity area TA can be effectively pressed at a high pressure in the below-described press molding step. Therefore, the effect of the art disclosed herein can be brought out at a higher level. The elastic modulus of the first adhesive layer region 34a (or the second adhesive layer region 34b) can be worked out in accordance with the following procedure.

(Procedure 1) Multiple (for instance from about 100 to 400) separators prior to application of the first adhesive layer region 34a (or the second adhesive layer region 34b) (in other words, just the base material layer 32) are laid up on each other, so that the influence of measuring device strain is negligible, to prepare a test piece A.

(Procedure 2) Multiple (for instance from about 100 to 400) separators in which the first adhesive layer region 34a (or second adhesive layer region 34b) has been applied onto the entire surface of the base material layer 32 are laid up on each other, so that the influence of measuring device strain is negligible, to prepare a test piece B.

(Procedure 3) The test pieces A and B are compressed, using a universal tester, through application of prescribed loads of for instance up to 1 MPa, 5 MPa, 10 MPa and 50 MPa, to the test pieces A and B.

(Procedure 4) An elastic modulus Es is then calculated in accordance with the expression below, where a1 denotes thickness at the time of compression of the test piece A under a load P1, a2 denotes thickness at the time of compression of the test piece A under load P2, b1 denotes the thickness of the test piece B under the load P1, and b2 denotes the thickness of the test piece B under the load P2:

Es=(P2−P1)/{(b1−A1)−(b2−A2)/(b1−A1)}

In the winding step (1-2) there is produced a cylindrical wound body (cylindrical body) that has the band-shaped positive electrode plate 10, the band-shaped negative electrode plate 20 and the band-shaped separators 30A. Specifically, a winding device provided with a winding unit is prepared first. Next, the separators 30A, the positive electrode plate 10 and the negative electrode plate 20 prepared above are each wound into a respective reel that is set in the winding device. Next, the tips of the two separators 30A are fixed to a winding core of the winding unit. That is, the two separators 30A are nipped by the winding core. Next, the band-shaped positive electrode plate 10 and the band-shaped negative electrode plate 20 are laid up on each other across two separators 30A interposed in between. At this time, the surface 32u of the base material layer 32 of each separator 30A are set to oppose the positive electrode plate 10, to thereby cause the first adhesive layer region 34a and the second adhesive layer region 34b to abut the positive electrode active material layer 14. The positional relationship between the positive electrode plate 10 and the separator 30A in the width direction Y is regulated so that the relatively thicker second adhesive layer region 34b, in the adhesive layer 34, opposes the tab vicinity area TA of the positive electrode active material layer 14. Similarly, the positional relationship between the negative electrode plate 20 and the separators 30A in the width direction Y is regulated so that the relatively thicker second adhesive layer region 34b, in the adhesive layer 34, opposes the tab vicinity area TA of the negative electrode active material layer 24.

The winding core is caused to rotate while the band-shaped positive electrode plate 10 and the band-shaped negative electrode plate 20 are supplied, to thereby wind the positive electrode plate 10, the negative electrode plate 20, and the separators 30A. Once winding is over, a winding stop tape (not shown) is attached to a termination portion of each separator 30A. A cylindrical body is produced thus as described above. In the cylindrical body multiple positive electrode tabs 12t of the positive electrode plate 10 protrude from one end portion in the width direction Y, while multiple negative electrode tabs 22t of the negative electrode plate 20 protrude from the other end portion in the width direction Y. The number of winding turns is preferably adjusted as appropriate taking into consideration for instance the intended performance of the battery 100 and production efficiency. The number of winding turns is preferably 20 or more. When the number of winding turns is large, the thickness T (see FIG. 5) increases; as a result the elastic action after press molding is significant, and the inter-electrode distance can increase readily. Moreover, the number of electrode tabs that make up the electrode tab groups increases, and as a result a large force is required to bend the electrode tab groups. In consequence, the tab vicinity area TA is likely to be acted upon by significant stress. However, the art disclosed herein allows suppressing sufficiently local increases in inter-electrode distance in the tab vicinity area TA.

(1-3) In the press molding step (2), the wound cylindrical body is press-molded to a flat shape, as illustrated in FIG. 7. Preferably, the press molding condition (for instance pressure, holding time and so forth) are regulated as appropriate for instance in accordance with the flexibility of the adhesive layer 34 and the number of winding turns. Press molding may be performed at room temperature, or may be performed while under heating (at a high temperature). As a result of press molding, the positive electrode tab group 42 in which the positive electrode tabs 12t are stacked becomes formed at one end portion in the width direction Y of the wound electrode body 40, while the negative electrode tab group 44 in which the negative electrode tabs 22t are stacked becomes formed at the other end portion. The reaction portion 46 in which the positive electrode active material layer 14 and the negative electrode active material layer 24 oppose each other becomes formed in the central portion of the wound electrode body 40 in the width direction Y. The wound electrode body 40 having the positive electrode plate 10, the negative electrode plate 20 and the separators 30 is thus produced as described above.

FIG. 10 is a diagram, corresponding to FIG. 8, for explaining a press molding step. In the present embodiment respective adhesive layers 34 of a given separator 30 are bonded to the positive electrode plate 10 and the negative electrode plate 20. Specifically, squashing the cylindrical body during the press molding results in large pressure being applied to the positive electrode plate 10, the negative electrode plate 20 and the separators 30 positioned in the flat portion 40f. In this case the adhesive particles contained in the adhesive layer 34 bite into the positive electrode active material layer 14 and the negative electrode active material layer 24, whereupon an anchor effect. Alternatively, the adhesive layer binder breaks apart while being squashed. As a result, the adhesive layer 34 is deformed, by being pressed, while conforming to the relief on the surface of the positive electrode active material layer 14 and the negative electrode active material layer 24. As a result, the positive electrode plate 10 and the separator 30 become bonded to each other, and the negative electrode plate 20 and the separator 30 likewise become bonded to each other.

As described above, in a case where the positive electrode active material layer 14 has the end area EA (see FIG. 8), pressure is applied less readily to the tab vicinity area TA that includes at least part of the end area EA. As a result, bonding between the positive electrode active material layer 14 and the separator 30 is weaker in the tab vicinity area TA, and the inter-electrode distance between the positive electrode plate 10 and the negative electrode plate 20 is prone to increase locally. However, in the art disclosed herein the thick second adhesive layer region 34b in the adhesive layer 34 opposes the tab vicinity area TA. As a result, surface pressure bears readily on the tab vicinity area TA, such that a surface pressure distribution can be made uniform. As a result it becomes possible to suppress local increases in inter-electrode distance in the tab vicinity area TA, and to make uniform the inter-electrode distance between the positive electrode plate 10 and the negative electrode plate 20.

The adhesive strength between the separator 30 and the electrode plates (the positive electrode plate 10 and/or the negative electrode plate 20), more specifically, the adhesive strength between the adhesive layer 34 and the electrode active material layers (positive electrode active material layer 14 and/or negative electrode active material layer 24), is preferably 0.5 N/m or higher, more preferably 0.75 N/m or higher, and yet more preferably 1.0 N/m or higher. Local increases in inter-electrode distance, and increases in inter-electrode distance derived from springback, can be more suitably suppressed as a result. The term “adhesive strength” in the present specification denotes 90° peel strength according to JIS Z0237.

The accommodation step (2) is a step of accommodating the wound electrode body 40 in the battery case 50. The accommodation step (2) typically includes: (2-1) an attaching step and (2-2) an insertion step, in this order.

(2-1) In the mounting step firstly there is produced a combined object such as that illustrated in FIG. 6. Specifically, the positive electrode second collector 72 is joined to the positive electrode tab group 42 of the wound electrode body 40, and the negative electrode second collector 77 is joined to the negative electrode tab group 44. Then, as illustrated in FIG. 5, multiple (three in the figure) wound electrode bodies 40 are arrayed so that respective flat portions 40f oppose each other. Next, a sealing plate 54 is disposed above the plurality of wound electrode bodies 40, and the positive electrode tab groups 42 of the wound electrode bodies 40 are curvedly bent so that the positive electrode second collectors 72 and one side face 40a of the wound electrode bodies 40 oppose each other. The positive electrode first collector 71 and the positive electrode second collectors 72 become connected as a result. Similarly, the negative electrode tab groups 44 of the wound electrode bodies 40 are curvedly bent so that the negative electrode second collectors 77 and the other side face 40b of the wound electrode bodies 40 oppose each other. The negative electrode first collector 76 and the negative electrode second collectors 77 become connected thereby. As a result, the wound electrode bodies 40 become attached to the sealing plate 54, with the positive electrode collector 70 and the negative electrode collector 75 interposed therebetween.

When the positive electrode tab groups 42 and the negative electrode tab groups 44 are bent in the above-described connection between the sealing plate 54 and the wound electrode bodies 40, the positive electrode plates 10 and/or the negative electrode plates 20 may exhibit waviness (distortion), and the inter-electrode distances between respective positive electrode plates 10 and negative electrode plates 20 may increase. At the time of bending, significant stress acts on the tab vicinity area TA of the positive electrode active material layer 14 and the negative electrode active material layer 24, and as a result a force is exerted that urges widening of the inter-electrode distance between respective positive electrode plates 10 and negative electrode plates 20. As a result, the electrolyte solution pools in the tab vicinity area TA, and formation of a coating film at that site is promoted, which may result in increased resistance. Also, charge transfer resistance may increase in the tab vicinity area TA, and battery reactions may become non-uniform. In the present embodiment, however, the positive electrode plate 10, the separators 30 and the negative electrode plate 20 are bonded together, and accordingly increases in inter-electrode distance can be prevented even if stress acts on the tab vicinity area TA upon bending of the positive electrode tab groups 42.

In the insertion step (2-2) the wound electrode bodies 40 attached to the sealing plate 54 are covered with the electrode body holder 98 (see FIG. 3), and thereafter the whole is accommodated inside the exterior body 52. As a result, the flat portion 40f of each wound electrode body 40 opposes the long side walls 52b of the exterior body 52 (i.e. the flat surface of the battery case 50). The upper curved portions 40r oppose the sealing plate 54, and the lower curved portions 40r oppose the bottom wall 52a of the exterior body 52. Next, the opening 52h at the top face of the exterior body 52 is plugged by the sealing plate 54, after which the exterior body 52 and the sealing plate 54 are joined (typically, welded), to thereby construct the battery case 50. Next, the electrolyte solution is injected into the battery case 50 through the liquid injection hole 55 of the sealing plate 54, and the liquid injection hole 55 is plugged by the sealing member 56. The battery 100 becomes sealed thereby. The battery 100 can be produced thus as a result of the above steps.

Local increases in inter-electrode distance in the tab vicinity area TA are suppressed in the battery 100 thus produced. Also, springback of the wound electrode body 40 after press molding is suitably suppressed. As a result, the inter-electrode distance between the positive electrode active material layer 14 and the negative electrode active material layer 24 can be readily kept uniform. Variability in battery reactions is reduced as a result, and a battery boasting superior long-term cycle characteristics can be realized.

The battery 100 can be used for various applications, and can be suitably used for instance as a power source (drive power source) for motors mounted on vehicles such as passenger cars and trucks. The type of vehicle is not particularly limited, and examples thereof include plug-in hybrid automobiles (PHEVs; Plug-in Hybrid Electric Vehicles), hybrid automobiles (HEVs; Hybrid Electric Vehicles) and electric cars (BEVs; Battery Electric Vehicles). Battery reaction variability is suppressed in the battery 100, and hence the battery 100 can be suitably used for constructing an assembled battery.

Several embodiments of the present disclosure have been explained above, but these embodiments are merely illustrative in character. The present disclosure can be implemented in various other forms. The present disclosure can be implemented on the basis of the disclosure of the present specification and common technical knowledge in the relevant field. The art set forth in the claims encompasses various modifications and alterations of the embodiments illustrated above. For instance, other embodiment variations may substitute for part of the embodiments described above, or alternatively other embodiment variations may be added to embodiments described above. Moreover, a given feature may be expunged as appropriate if the feature is not explained as essential.

For instance, the battery case 50 in the embodiments described above accommodates three wound electrode bodies 40. However, the number of electrode bodies accommodated in one battery case is not particularly limited, and the accommodated electrode bodies may be two or more (plurality), or just one. In a battery 100 provided with a plurality of wound electrode bodies 40, such as that illustrated in FIG. 3, local increases in inter-electrode distance may occur in the vicinity of the electrode tab groups of the wound electrode bodies 40. By contrast, the art disclosed herein allows using a structure that curtails local increases in inter-electrode distance in each of the wound electrode bodies 40. The art disclosed herein can therefore be particularly suitably applied to a battery 100 having a plurality of wound electrode bodies 40.

For instance, in the above embodiments the first adhesive layer region 34a and the second adhesive layer region 34b are formed on the surface 32u, as illustrated in FIG. 9, to dotted shapes of identical dot size, as the adhesive layer 34 in the separator 30A prior to preparation of a respective wound electrode body 40 (in other words, prior to bonding to an electrode plate (positive electrode plate 10 and/or negative electrode plate 20)). Further, the elastic modulus of the second adhesive layer region 34b was higher than the elastic modulus of the first adhesive layer region 34a. However, the present disclosure is not limited thereto. For instance the first adhesive layer region 34a and/or the second adhesive layer region 34b may be formed to other shapes, such as stripes or bands. Also, the sizes of the dots that make up the first adhesive layer region 34a and the sizes of the dots that make up the second adhesive layer region 34b may mutually different. The elastic modulus of the second adhesive layer region 34b may be smaller than the elastic modulus of the first adhesive layer region 34a. In some embodiments the adhesive layer 34 can also adopt shapes as in the first through sixth variations below.

First Variation

FIG. 11 is a plan-view diagram illustrating schematically a separator 130A according to a first variation. The separator 130A includes, as an adhesive layer 134, a first adhesive layer region 134a and two second adhesive layer regions 134b thicker than the first adhesive layer region 134a, on a surface 132u of a base material layer 132; otherwise, the separator 130A may be identical to the above-described separator 30A. The second adhesive layer regions 134b are disposed at both end portions in the width direction TD, and the first adhesive layer region 134a is disposed between the two second adhesive layer regions 134b (central portion). The first adhesive layer region 134a and the second adhesive layer regions 134b are each formed to a dotted shape. The size of the dots that make up the second adhesive layer regions 134b is smaller than the size of the dots that make up the first adhesive layer region 134a. The spacing between the dots that make up the second adhesive layer regions 134b is larger than the spacing between the dots that make up the first adhesive layer region 134a. As a result it becomes possible to increase the permeability of the electrolyte solution into the central portion of the wound electrode body 40 in the width direction TD, and to enhance battery performance.

Second Variation

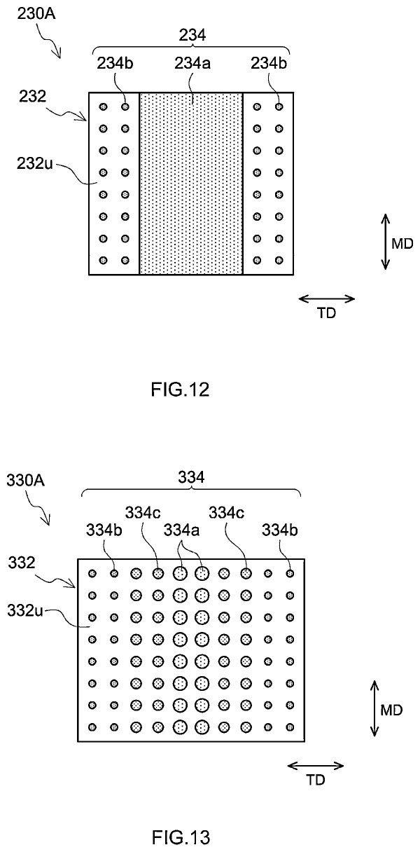

FIG. 12 is a plan-view diagram illustrating schematically a separator 230A according to a second variation. The separator 230A includes, as an adhesive layer 234, a first adhesive layer region 234a and two second adhesive layer regions 234b thicker than the first adhesive layer region 234a, on a surface 232u of a base material layer 232; otherwise, the separator 230A may be identical to the above-described separator 130A. The first adhesive layer region 234a are formed to a band shape extending in the longitudinal direction MD. The second adhesive layer regions 234b is formed to a dotted shape. The size of the dots that make up the second adhesive layer regions 234b is smaller than the spacing between the dots that make up the second adhesive layer regions 234b. A ratio of the size of the dots relative to the spacing between dots (dot size/dot spacing) can be for instance 1/2 or lower, and further 1/3 or lower. As a result, gas can be prevented from accumulating inside the wound electrode body 40, and battery performance can be improved.

Third Variation

FIG. 13 is a plan-view diagram illustrating schematically a separator 330A according to a third variation. The separator 330A includes, as an adhesive layer 334, a first adhesive layer region 334a, two second adhesive layer regions 334b thicker than the first adhesive layer region 334a, and moreover, two third adhesive layer regions 334c having a thickness intermediate between the those of the first adhesive layer region 334a and the second adhesive layer regions 334b, on a surface 332u of a base material layer 332; otherwise, the separator 330A may be identical to the above-described separator 130A. The third adhesive layer regions 334c are disposed between the first adhesive layer region 334a and the second adhesive layer regions 334b, in the width direction TD. As a result, in the present implementation the thickness of the adhesive layer 334 decreases stepwise from the central portion towards the end portions, in the width direction TD. The first adhesive layer region 334a, the second adhesive layer regions 334b, and the third adhesive layer regions 334c are each formed to a dotted shape. The size of the dots that make up each adhesive layer region decreases in the order from the largest in the first adhesive layer region 334a positioned at the central portion in the width direction TD, then the third adhesive layer regions 334c, and then the second adhesive layer regions 334b. As a result it becomes possible to increase the permeability of the electrolyte solution into the central portion of the wound electrode body 40 in the width direction TD, and to enhance battery performance. In the electrode body production step described above, moreover, stress on the separator 330A wound in the form of a reel can be dispersed, and local sagging can be suppressed.

Fourth Variation

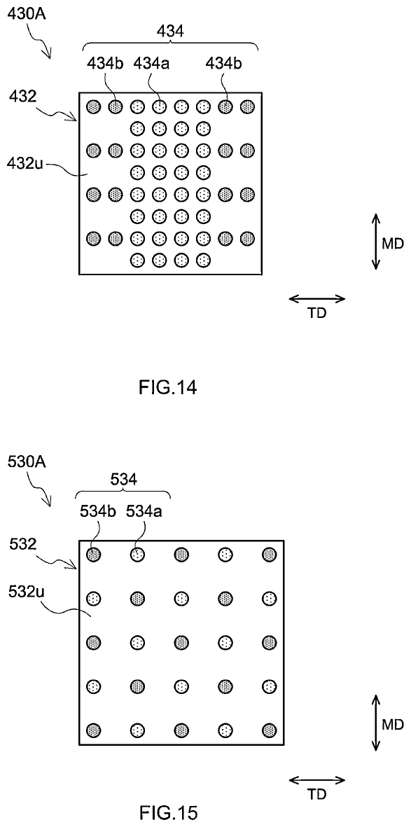

FIG. 14 is a plan-view diagram illustrating schematically a separator 430A according to a fourth variation. The separator 430A includes, as an adhesive layer 434, a first adhesive layer region 434a and second adhesive layer regions 434b thicker than the first adhesive layer region 434a, on a surface 432u of a base material layer 432; otherwise, the separator 430A may be identical to the above-described separator 130A. The dots that make up each adhesive layer region have the same size. The number of the dots that make up the second adhesive layer regions 434b is smaller than the number of the dots that make up the first adhesive layer region 434a. The spacing between the dots that make up the second adhesive layer regions 434b is larger than the spacing between the dots that make up the first adhesive layer region 434a. The spacing between the dots that make up the second adhesive layer regions 434b may be for instance twice or more the spacing between the dots that make up the first adhesive layer region 434a. As a result it becomes possible to increase the permeability of the electrolyte solution into the central portion of the wound electrode body 40 in the width direction TD, and to enhance battery performance. In addition, rapid charge/discharge characteristics can be improved, since the electrolyte solution can readily flow into and out of the wound electrode body 40.

Fifth Variation

FIG. 15 is a plan-view diagram illustrating schematically a separator 530A according to a fifth variation. The separator 530A includes, as an adhesive layer 534, a first adhesive layer region 534a and a second adhesive layer region 534b thicker than the first adhesive layer region 534a, on a surface 532u of a base material layer 532; otherwise, the separator 530A may be identical to the above-described separator 30A. The first adhesive layer region 534a and the second adhesive layer region 534b are each formed to a dotted shape. The dots that make up each adhesive layer region have the same size. On the surface 532u the dots that make up the first adhesive layer region 534a are disposed between the dots that make up the second adhesive layer region 534b. That is, the first adhesive layer region 534a and the second adhesive layer region 534b are intermixed in a plan view. The dots that make up the first adhesive layer region 534a and the dots that make up the second adhesive layer region 534b are alternately juxtaposed in the longitudinal direction MD and the width direction TD. The adhesive layer 534 is disposed thus in a well-balanced manner (uniformly), specifically in the longitudinal direction MD and the width direction TD, within the surface 532u. As a result it becomes possible to increase the permeability of the electrolyte solution into the central portion of the wound electrode body 40 in the width direction TD, and to enhance battery performance. In the electrode body production step described above, moreover, stress on the separator can be dispersed, and local sagging can be suppressed.

While not bound to any limiting interpretation, the inventors surmise the following concerning underlying factors of the effect disclosed therein, also as pertaining to the present variation and a below-described sixth variation. Specifically, in a case where the thickness of the adhesive layer is large overall (or uniform), the distribution of the surface pressure depends on the thickness of the electrode plate in the press molding step, and adhesive strength with the electrode plates is weaker at thin portions (for instance the above-described tab vicinity area). By contrast, pressure is exerted readily on a thick site, by intermixing a thick portion (second adhesive layer region 534b) and a thin portion (first adhesive layer region 534a) in the plane of the separator, as in the present variation. It is deemed that, as a result, the surface pressure distribution depending on the electrode plates can be eased, and the adhesive strength in the tab vicinity area can be made relatively higher as compared with a case where the thickness of the adhesive layer is uniform.

Sixth Variation

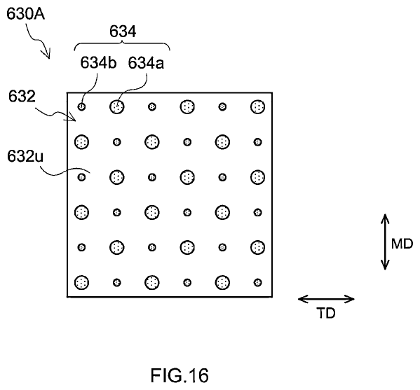

FIG. 16 is a plan-view diagram illustrating schematically a separator 630A according to a sixth modification. The separator 630A includes, as an adhesive layer 634, a first adhesive layer region 634a and a second adhesive layer region 634b thicker than the first adhesive layer region 634a, on a surface 632u of a base material layer 632; otherwise, the separator 630A may be identical to the above-described separator 530A. The size of the dots that make up the second adhesive layer region 634b is smaller than the diameter of the plurality of dots that make up the first adhesive layer region 634a, and is for instance half or less the size of the dots that make up the first adhesive layer region 634a. As a result, the surface area over which the electrode active material layers are bonded (covered by the adhesive particles) after press molding can be reduced, and battery performance can be improved, in addition to the effects described in the fifth variation.

What is claimed is:

1. A method for producing a battery that has
an electrode body that includes a first electrode, a second electrode, and a separator disposed between the first electrode and the second electrode; and
a battery case that accommodates the electrode body,
with the first electrode being configured to include a first electrode core body, and a first electrode active material layer formed on the first electrode core body, and have a first active material layer non-formation area at which the first electrode core body is exposed,
the method comprising:
an electrode body production step of producing the electrode body by laying up the first electrode, the separator and the second electrode; and
an accommodation step of accommodating the electrode body in the battery case,
wherein in the electrode body production step,
as the separator, a separator is used that includes a base material layer, and an adhesive layer formed on at least one surface of the base material layer, the adhesive layer being configured to have a first adhesive layer region and a second adhesive layer region that is thicker than the first adhesive layer region, and
the first electrode and the separator are laid up so that the first adhesive layer region and the second adhesive layer region oppose the first electrode active material layer.

2. The method for producing a battery according to claim 1, wherein in the electrode body production step,
the first electrode and the separator are laid up so that a tab vicinity area of the first electrode active material layer in the vicinity of the first active material layer non-formation area and the second adhesive layer region of the adhesive layer oppose each other.

3. The method for producing a battery according to claim 1, wherein
the second electrode includes a second electrode core body, a second electrode active material layer formed on the second electrode core body, and a second active material layer non-formation area at which the second electrode core body is exposed; and
in the electrode body production step,
the second electrode and the separator are laid up so that a tab vicinity area of the second electrode active material layer in the vicinity of the second active material layer non-formation area and the second adhesive layer region of the adhesive layer oppose each other.

4. The method for producing a battery according to claim 1,
wherein as the separator a separator is used in which, in a plan view, at least the second adhesive layer region is formed to have a dotted shape.

5. The method for producing a battery according to claim 4, wherein as the separator a separator is used in which, in plan view, each of the first adhesive layer region and the second adhesive layer region are formed to have a dotted shape, such that a size of dots that make up the second adhesive layer region is smaller than a size of dots that make up the first adhesive layer region.

6. The method for producing a battery according to claim 1, wherein as the separator a separator is used in which, in a plan view, each of the first adhesive layer region and the second adhesive layer region are formed to have a dotted shape, the first adhesive layer region and the second adhesive layer region being intermixed such that dots of the first adhesive layer region are disposed between multiple dots of the second adhesive layer region.

7. The method for producing a battery according to claim 4, wherein as the separator a separator is used in which the first adhesive layer region is formed to have a band shape.

8. The method for producing a battery according to claim 4, wherein as the separator a separator is used in which a plurality of adhesive particles are contained in the second adhesive layer region.

9. The method for producing a battery according to claim 1, wherein as the separator a separator is used in which an elastic modulus of the second adhesive layer region is higher than an elastic modulus of the first adhesive layer region.

10. The method for producing a battery according to claim 1, wherein in the electrode body production step,
a wound electrode body is produced through winding of the first electrode, which is shaped as a band, and the second electrode, which is shaped as a band, across the separator, which is shaped as a band.

11. The method for producing a battery according to claim 3, wherein in the electrode body production step,
a plurality of first electrode tabs are provided so as to include the first active material layer non-formation area at one end portion of the electrode body, and a plurality of second electrode tabs are provided so as to include the second active material layer non-formation area at the other end portion of the electrode body.
